(19) United States
(12) Patent Application Publication
(10) Pub. No.: US 2003/0088758 A1
(43) Pub. Date: May 8, 2003

(54) Methods and systems for determining valid microprocessor instructions

(76) Inventors: Matthew Becker, Maxwell AFB, AL (US); Masooma Bhaiwala, Andover, MA (US)

Correspondence Address: Steven Gardner, Kilpatrick Stockton LLP, 1001 West Fourth Street, Winston Salem, NC, 27101-2400, US

(21) Appl. No.: 10/010,389

(22) Filed: Nov. 8, 2001

(51) Int. Cl. G06F 9/30

(52) U.S. Cl. 712/214; 712/24

(57) ABSTRACT

Methods and systems are disclosed for calculating the number of valid instructions in a microprocessor instruction bundle. One method advances the instructions along the pipeline and edge detects the number of valid instructions within the pipeline. Another method fetches a bundle of instructions, shifts instructions within the bundle, and edge detects the valid instructions. Still another method fetches the bundle of instructions and detects a complex instruction within the bundle. Instructions occurring after the complex instruction are shifted, and the number of valid instructions occurring after the complex instruction are edge detected.

### BACKGROUND OF THE INVENTION

1. Field of the Invention

This invention generally relates to computer systems and, more particularly, to methods and to systems for calculating the number of valid instructions within a microprocessor instruction bundle.

2. Description of the Related Art

Superscaler microprocessor designs fetch multiple instructions per clock cycle. These multiple instructions are bundled and sent along a pipeline for execution. Sometimes, however, not all instructions within the bundle are valid instructions. That is, some instructions within the bundle may be invalid and, thus, need not be executed. The architecture of the microprocessor, therefore, includes circuitry to calculate the number of valid instructions within a particular instruction bundle.

A population counter is generally used to determine the number of valid instructions within the instruction bundle. This population counter is a logic circuit that counts the number of valid instructions in each instruction bundle.

A population counter, however, is a complex circuit. Because this full population count sometimes must be performed during one clock cycle, the logic circuit may limit the cycle time. The population counter also consumes unnecessary power and hinders the design of lower-powered microprocessors. The complex population counter also contributes to heat management problems within the microprocessor.

There is, accordingly, a need in the art for methods and circuits that quickly determine the number of valid instructions within an instruction bundle, that are less complex to design and to implement, and that consume less power and that generate less heat.

### BRIEF SUMMARY OF THE INVENTION

The aforementioned problems are reduced by the present invention. The present invention comprises methods and systems for calculating the number of valid instructions within a microprocessor instruction bundle. These methods and systems utilize edge detection to determine the number of valid instructions within the instruction bundle. Because the instructions are monotonically arranged within the instruction bundle, edge detection may be used to determine where the valid instructions lie within the bundle. Even if the valid instructions are not monotonically arranged within the instruction bundle, the present invention may shift valid instructions to the top of the instruction bundle. The valid instructions will now lie onward from the first instruction slot within the bundle. An invalid instruction, encountered before valid instructions, is considered valid, but, is marked “not executable.” That way only instructions after the last valid instruction within the bundle will be invalid. The number of valid instructions within the bundle may now be determined using the faster and simpler method of edge detection.

### BRIEF DESCRIPTION OF THE SEVERAL VIEWS OF THE DRAWINGS

These and other features, aspects, and advantages of the present invention are better understood when the following Detailed Description of the Invention is read with reference to the accompanying drawings, wherein:

FIG. 1 depicts a possible operating environment for one embodiment of the present invention;

FIG. 2 is a block diagram of a microprocessor;

FIGS. 3 and 4 are block diagrams of a microprocessor pipeline;

FIG. 5 is a block diagram of an instruction bundle;

FIG. 6 is a block diagram illustrating one embodiment of the present invention;

FIG. 7 is a block diagram illustrating the execution of a complex microprocessor instruction; and

FIG. 8 is a block diagram illustrating another embodiment of the present invention.

### DETAILED DESCRIPTION OF THE INVENTION

One embodiment of the present invention comprises a method for calculating the number of valid instructions within a microprocessor instruction bundle. This embodiment advances the instructions along the pipeline and edge detects the number of valid instructions within the pipeline.

Another embodiment fetches a bundle of instructions from cache memory. The instructions within the bundle are shifted. The valid instructions are then edge detected.

In a further embodiment, which fetches the bundle of instructions, a complex instruction within the bundle is detected. Instructions occurring after the complex instruction are shifted, and the number of valid instructions occurring after the complex instruction are edge detected.

In another embodiment of the present invention, the bundle of instructions is fetched and the complex instruction is detected. The valid instructions occurring prior to the complex instruction are executed during a first clock cycle, and the complex instruction is executed during a second clock cycle. The instructions occurring after the complex instruction are shifted during at least one of the first clock cycle and the second clock cycle. The number of valid instructions occurring after the complex instruction are edge detected during at least one of the first clock cycle and the second clock cycle. The valid instructions occurring after the complex instruction are then executed during a third clock cycle.

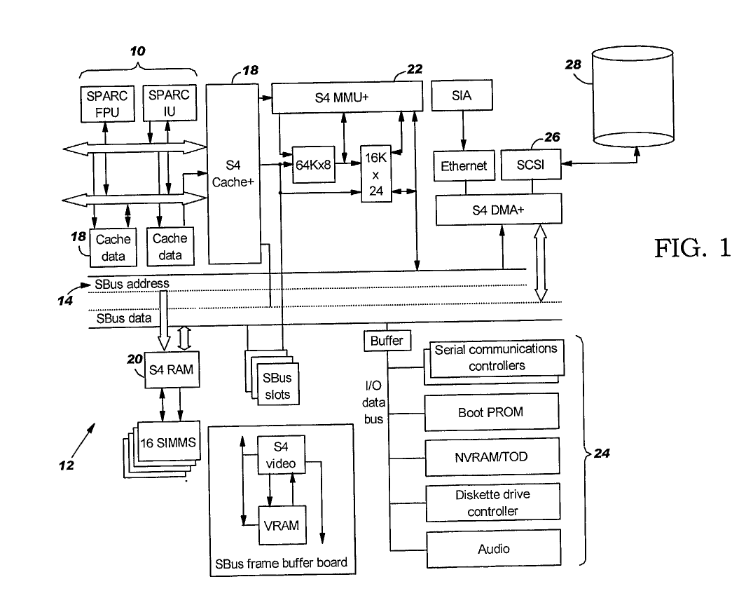

FIG. 1 depicts a possible operating environment for one embodiment of the present invention. FIG. 1 illustrates a microprocessor 10 operating within a computer system 12. The computer system 12 includes a bus 14 communicating information between the microprocessor 10, cache memory 18, Random Access Memory 20, a Memory Management Unit 22, one or more input/output controller chips 24, and a Small Computer System Interface (SCSI) controller 26. The SCSI controller 26 interfaces with SCSI devices, such as mass storage hard disk drive 28. Although FIG. 1 describes the general configuration of computer hardware in a computer system, those of ordinary skill in the art understand that the present invention described in this patent is not limited to any particular computer system or computer hardware.

Those of ordinary skill in the art also understand the present invention is not limited to any particular manufacturer's microprocessor design. Sun Microsystems, for example, designs and manufactures high-end 64-bit and 32-bit microprocessors for networking and intensive computer needs (Sun Microsystems, Inc., 901 San Antonio Road, Palo Alto Calif. 94303, www.sun.com). Advanced Micro Devices (Advanced Micro Devices, Inc., One AMD Place, P.O. Box 3453, Sunnyvale, Calif. 94088-3453, 408.732.2400, 800.538.8450, www.amd.com) and Intel (Intel Corporation, 2200 Mission College Blvd., Santa Clara, Calif. 95052-8119, 408.765.8080, www.intel.com) also manufacture various families of microprocessors. Other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). While only one microprocessor is shown, those skilled in the art also recognize the present invention is applicable to computer systems utilizing multiple processors.

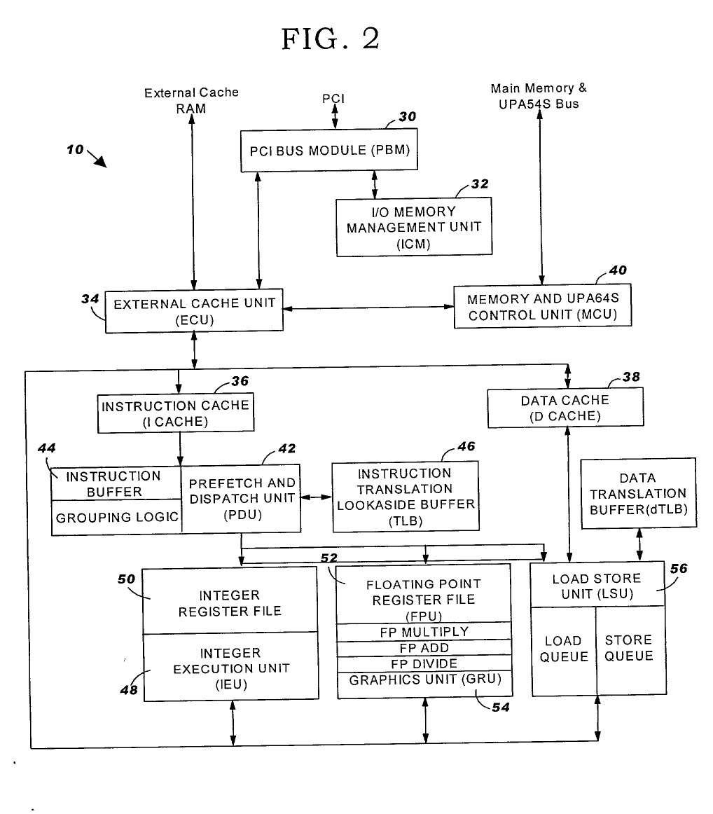

FIG. 2 is a block diagram of the microprocessor 10. Because, however, the terms and concepts of art in microprocessor design are readily known those of ordinary skill, the microprocessor 10 shown in FIG. 2 is only briefly described. The microprocessor 10 uses a PCI bus module 30 to interface with a PCI bus (not shown for simplicity). An Input/Output Memory Management Unit (IOM) 32 performs address translations, and an External Cache Unit (ECU) 34 manages the use of external cache (not shown for simplicity) for instruction cache 36 and for data cache 38. A Memory Control Unit (MCU) 40 manages transactions to dynamic random access memory (DRAM) and to other subsystems. A Prefetch and Dispatch Unit (PDU) 42 fetches an instruction before the instruction is needed. Prefetching instructions helps ensure the microprocessor does not “starve” for instructions and slow the execution of instructions. The Prefetching and Dispatch Unit (PDU) 42 may even attempt to predict what instructions are coming in the pipeline, thus, further speeding the execution of instructions. A fetched instruction is stored in an instruction buffer 44. An Instruction Translation Lookaside Buffer (ITLB) 46 provides mapping between virtual addresses and physical addresses. An Integer Execution Unit (IEU) 48, along with an Integer Register File 50, supports a multi-cycle integer multiplier and a multi-cycle integer divider. A Floating Point Unit (FPU) 52 issues and executes one or more floating point instructions per cycle. A Graphics Unit (GRU) 54 provides graphics instructions for image, audio, and video processing. A Load/Store Unit (LSU) 56 generates virtual addresses for the loading and for the storing of information.

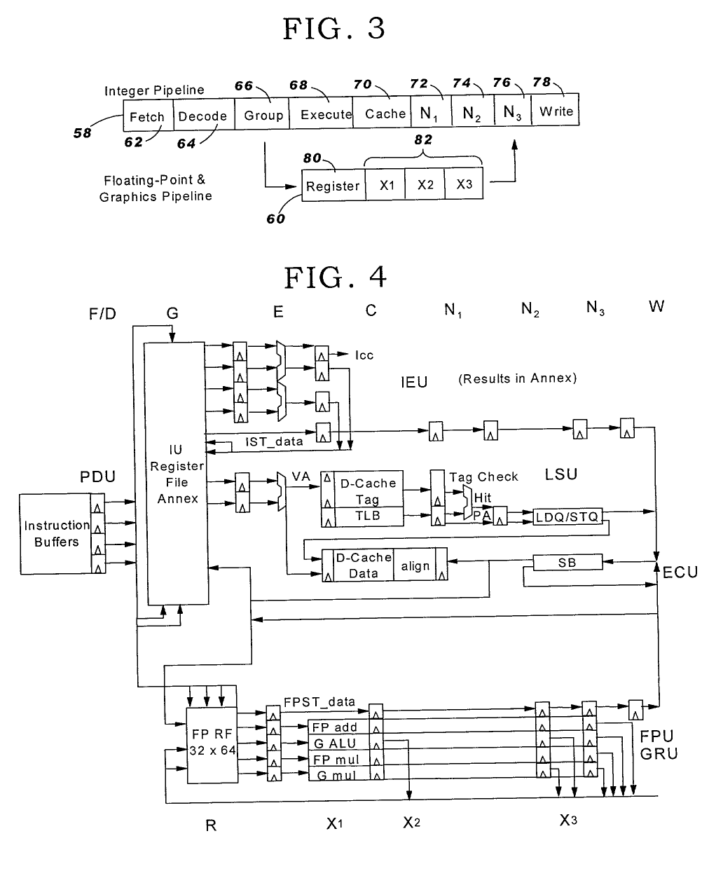

FIGS. 3 and 4 are block diagrams of a nine-stage pipeline. FIG. 3 is a simplified block diagram showing an integer pipeline 58 and a floating-point pipeline 60. FIG. 4 is a detailed block diagram of the pipeline stages. An instruction to the microprocessor (shown as reference numeral 10 in FIGS. 1 and 2) advances through the integer pipeline 58 and the floating-point pipeline 60 in one of these stages. The integer pipeline 58 has three additional stages, N₁, N₂, and N₃. These additional stages make the integer pipeline 58 symmetrical with the floating point pipeline 60. Because the general concept of a pipelined microprocessor has been known for over ten (10) years, the stages are only briefly described. The nine stages of the integer pipeline 58 include a fetch stage 62, a decode stage 64, a grouping stage 66, an execution stage 68, a cache access stage 70, a miss/hit stage 72, an executed floating point instruction stage 74, a trap stage 76, and a write stage 78. The floating-point pipeline 60 has a register stage 80 and execution stages X₁, X₂, and X₃ (shown as reference numeral 82). Prior to an instruction being executed, the instruction is fetched from the instruction cache unit (shown as reference numeral 36 in FIG. 3) and placed in the instruction buffer (shown as reference numeral 44 in FIG. 2). Because the Prefetch and Dispatch Unit (shown as reference numeral 42 in FIG. 2) may also predict an instruction to speed processing, a predicted instruction is also stored in the instruction buffer. The decode stage 64 retrieves a fetched instruction stored in the instruction buffer, pre-decodes the fetched instruction, and then return stores pre-decoded bits in the instruction buffer. The grouping stage 66 receives, groups, and dispatches one or more valid instructions per cycle. The grouping stage 66, for example, could receive four (4) valid instructions from the Prefetch and Dispatch Unit. Up to two (2) floating-point instructions, or two (2) graphics instructions, from the four valid candidates could be sent to the Floating Point Unit and/or to the Graphics Unit (shown respectively as reference numerals 52 and 54 in FIG. 2).

After an instruction has been fetched, decoded, and grouped, the instruction is executed at the execution stage 68. Data from the integer register file (shown as reference numeral 50 in FIG. 2) is processed by two integer Arithmetic Logic Units. Results are computed and made available for other instructions in the next cycle. Virtual memory addresses of any memory operations are also calculated in parallel during the execution stage. The floating-point pipeline 60, at the register stage 80, accesses a floating point register file, further decodes instructions, and selects bypasses for current instructions. The cache stage 70 sends virtual addresses of memory operations to RAM to determine hits and misses in the data cache. These virtual addresses are also sent in parallel to the Input/Output Memory Management Unit (shown as reference numeral 32 in FIG. 2) for physical address translation. Arithmetic Logic Unit operations generate condition codes in the cache stage 70. These condition codes are sent to the Prefetching and Dispatch Unit (shown as reference numeral 42 in FIG. 2). The Prefetching and Dispatch Unit checks whether conditional branches were correctly predicted and whether a pipeline flush is required. The X₁ stage 82 of the floating-point pipeline 60 starts the execution of floating-point and graphics instructions.

Data cache miss/hits are determined during the N₁ stage 72. If a load misses the data cache, the load enters a load buffer. The physical address of a store is also sent to a store buffer during the N₁ stage 72. If store data is not immediately available, store addresses and data parts are decoupled and separately sent to the store buffer. This separation helps avoid pipeline stalls when store data is not immediately available. The symmetrical X₂ stage 82 in the floating-point pipeline 60 continues executing floating point and graphics instructions.

Most floating-point instructions complete execution in the N₂ stage 74. Once the floating-point instructions complete execution, data may be bypassed to other stages or forwarded to a data portion of the store buffer. All loads entered into the load buffer during the N₁ stage 72 continue progressing through the load buffer and reappear in the pipeline only when data returns. All results, whether integer or floating-point, are written to register files in the write stage 78. All actions performed during the write stage 78 are irreversible and considered terminated.

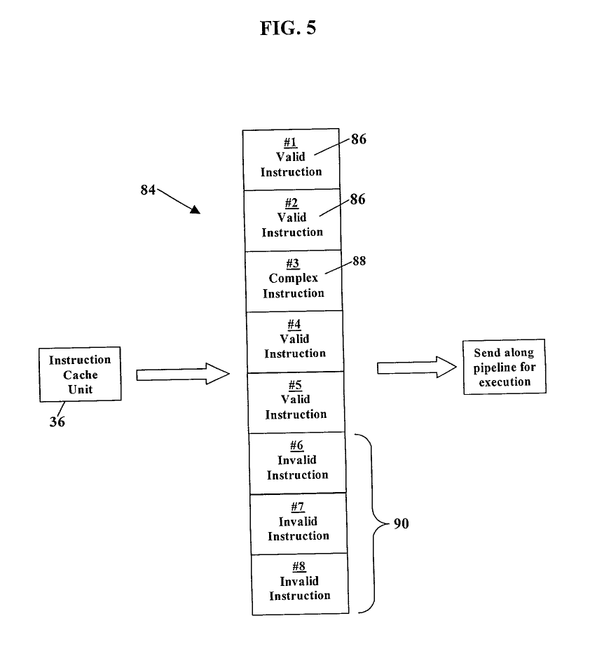

FIG. 5 is a block diagram of an instruction bundle 84. The instruction bundle 84 comprises eight (8) instructions that are fetched from the instruction cache unit 36. Superscalar microprocessor designs, such as the microprocessor 10 shown in FIG. 2, achieve high performance by executing multiple instructions per clock cycle. Because multiple instructions are executed per clock cycle, the instruction cache unit 36 fetches multiple instructions during each clock cycle. The term “clock cycle,” as used herein, refers to an interval of time accorded to various stages of the instruction processing pipeline within the microprocessor.

As FIG. 5 shows, the instruction bundle 84 may comprise valid instructions 86, complex instructions 88, and invalid instructions 90. Each instruction has an associated valid bit and an error bit. When the valid bit is set high (or “1”), the instruction associated with that valid bit is recognized as a valid instruction. When the error bit, conversely, is set high (and thus the valid bit is set low or “0”), the instruction associated with that error bit is invalid. The complex instruction 88 is a more complex instruction that is executed by hardware. The complex instruction 88 contains helper instructions—these helper instructions require more hardware tasks, so the helper instructions are broken down into smaller instructions and then executed. Even though the instruction bundle 84 may contain valid instructions 86, complex instructions 88, and invalid instructions 90, these instructions are guaranteed to be monotonically valid. “Monotonically” valid means that all the valid instructions 86, having their respective valid bit set high (or “1”), are at the front, or “top,” of the instruction bundle 84. Any invalid instructions 90, having their respective valid bit set low (or “0”), are at the back, or the “bottom,” of the instruction bundle 84. The number of valid instructions within the bundle is necessary, for a computer system's resources are allocated based upon the number of valid instructions.

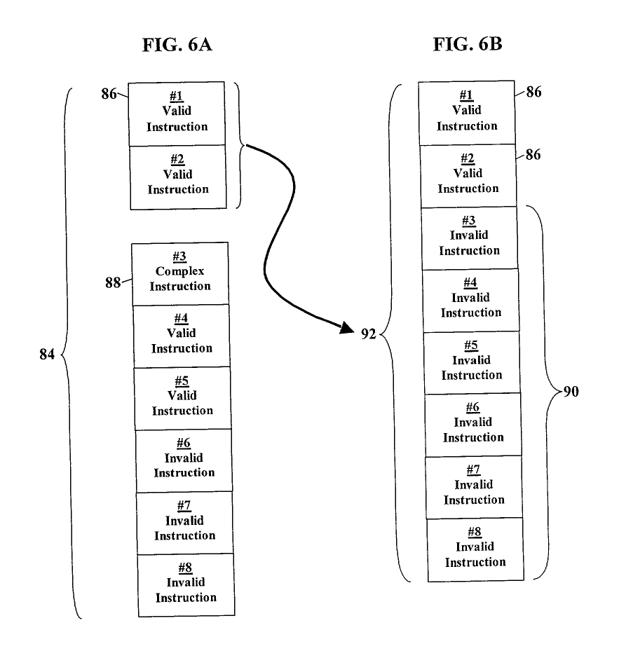

FIG. 6 is a block diagram illustrating one embodiment of the present invention for determining the number of valid instructions 86 within the instruction bundle 84. When the complex instruction 88 is detected, the original instruction bundle 84 is broken at the instruction prior to the complex instruction 88. FIG. 6A shows, therefore, the original instruction bundle 84 is broken at instruction #2. Instructions #1 and #2 are treated as a first new instruction bundle 92, shown in FIG. 6B, with all other instructions in the first new instruction bundle 92 marked as invalid instructions 90. Because the first new instruction bundle 92 is monotonic—that is, all the valid instructions, and corresponding valid bits, are compressed at the “top” of the bundle 92—the number of valid instructions in the bundle 92 may be edge detected. An edge detection circuit may be used to detect when the string of valid bits, corresponding to each valid instruction, transitions from high (“1”) to low (“0”). The monotonic nature of the bundle ensures any valid instructions will lie from the first instruction slot #1 and onward. Once an invalid instruction is encountered, every instruction afterwards will be invalid. The edge detect circuit, therefore, detects a “1” to “0” transition and stops—there's no need to population count the number of valid bits in each slot in the bundle. During a first clock cycle, therefore, the valid instructions #1 and #2, of the first new instruction bundle 92, are sent for execution along the pipeline.

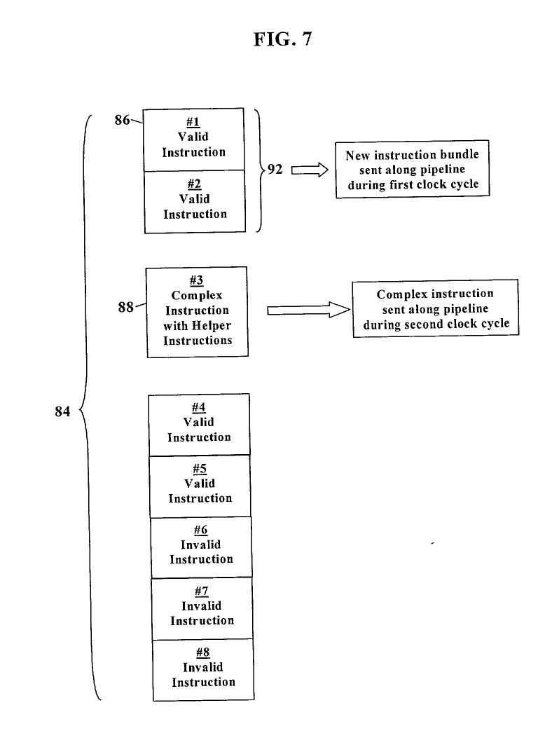

FIG. 7 is a block diagram illustrating the execution of the complex instruction 88. With the valid instructions #1 and #2, of the first new instruction bundle 92, sent for execution during the first clock cycle, the complex instruction 88, with its helper instructions, is sent for execution during a next second clock cycle. Once these helper instructions are executed, the remaining instructions #4-#8, in the original instruction bundle 84, must be sent for execution.

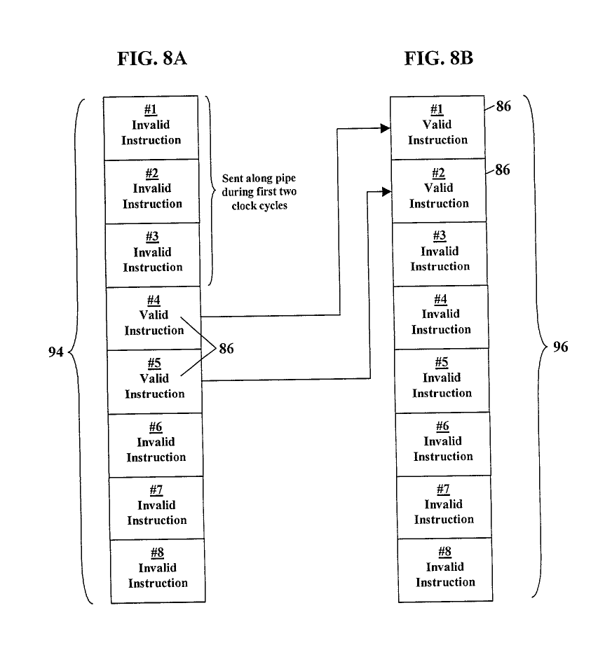

FIG. 8 is a block diagram illustrating another embodiment of the present invention for determining the number of valid instructions within an instruction bundle. FIG. 8A shows what remains of the original instruction bundle (shown as reference numeral 84 in FIGS. 5-7), while FIG. 8B shows a shifted instruction bundle. The original instruction bundle, to recap, was broken to form the first new instruction bundle (shown as reference numeral 92 in FIG. 6B). The valid instructions of the first new instruction bundle, previously occupying instruction slots #1 and #2, were sent for execution during the first clock cycle. The complex instruction (shown as reference numeral 88 in FIGS. 5-7), previously occupying instruction slot #3, was sent for execution during the second clock cycle. Thus the first three instruction slots #1-#3, within the original instruction bundle, have been sent for execution during the first two clock cycles. FIG. 8A shows that what remains of the original instruction bundle, now termed the remaining instruction bundle 94, is no longer monotonic—that is, the valid instructions 86 are sparsely populated within the remaining instruction bundle 94. Because the number of valid instructions within the remaining instruction bundle 94 must again be determined to allocate system resources, an edge detection circuit may again be used.

FIGS. 8A and 8B show the valid instructions 86 may be shifted to form a monotonic bundle. Because the instructions in slots #1-#3 were sent for execution during the first two clock cycles, the remaining valid instructions 86 may be shifted up to the top of the bundle. This shifting process produces a shifted instruction bundle 96 shown in FIG. 8B. Notice however, that this shifting process again ensures a monotonic arrangement—all the valid instructions 86, and their corresponding valid bits, are shifted to the “top” of the shifted instruction bundle 96. The number of valid instructions in the shifted instruction bundle 96 may then be determined with an edge detection circuit. Edge detecting the valid bit transitions from high (“1”) to low (“0”) allows the number of valid instructions to be quickly determined. Because the shifted instruction bundle 96 is now monotonic, once an invalid instruction is encountered, every instruction afterwards will be invalid. There is no need to population count the number of valid bits within each slot in the shifted instruction bundle 96.

Timing slack permits the shifting and edge detection of the valid instructions. Because the instructions in slots #1-#3 were sent for execution during the first two clock cycles, the remaining valid instructions the original instruction bundle (shown as reference numeral 84 in FIG. 5-7) are not sent for execution until the third clock cycle. The shifted instruction bundle 96, in other words, is not sent for execution until after the valid instructions 86, prior to the complex instruction 88, are sent for execution during the first clock cycle, and until after the complex instruction 88 is sent for execution during the second clock cycle. Thus the bundling of the valid instructions occurring prior to the complex instruction 88, and the bundling of the helper instructions, creates timing slack that allows shifting and edge detecting the remaining valid instructions in the shifted instruction bundle 96.

Edge detecting the valid instructions within a bundle is a simpler and faster method. The previous method of population counting the number of valid bits in a bundle required a complex circuit. An edge detection circuit, however, is simpler in design and in implementation. Edge detection is also faster that performing a full population count. Because edge detection is simpler and faster, other benefits are produced. Edge detection circuit 1) allows earlier computation of instruction identification (IID), 2) allows earlier computation of rotational amounts, and 3) allows more timely RAM read/write operation. Edge detection also reduces the loading seen by drivers in the core microprocessor blocks.

While this invention has been described with respect to various features, aspects, and embodiments, those skilled and unskilled in the art will recognize the invention is not so limited. Other variations, modifications, and alternative embodiments may be made without departing from the spirit and scope of the following claims.

What is claimed is:

1. A method, comprising:
advancing instructions along a microprocessor pipeline; and
edge detecting valid instructions within the microprocessor pipeline.

2. A method, comprising:
fetching a bundle of instructions; and
edge detecting valid instructions within the bundle.

3. A method according to claim 2, further comprising shifting at least one instruction within the bundle

4. A method according to claim 3, further comprising rotating at least one instruction based at least in part on the number of valid instructions in the bundle.

5. A method according to claim 3, further comprising compressing the bundle of instructions.

6. A method according to claim 3, further comprising compressing the bundle of instructions for a monotonic instruction set.

7. A method according to claim 3, further comprising compressing the bundle of instructions based at least in part on the number of valid instructions in the bundle.

8. A method, comprising:
fetching a bundle of instructions having a complex instruction;
shifting at least one instruction occurring after the complex instruction; and
edge detecting the number of valid instructions occurring after the complex instruction.

9. A method according to claim 8, further comprising bundling instructions occurring prior to the complex instruction.

10. A method according to claim 8, further comprising executing instructions occurring before the complex instruction.

11. A method according to claim 8, further comprising bundling instructions occurring after the complex instruction.

12. A method according to claim 8, wherein the step of shifting the instructions comprises compressing the instructions occurring after the complex instruction.

13. A method according to claim 8, wherein the step of shifting the instructions comprises compressing the instructions occurring after the complex instruction for a monotonic instruction set.

14. A method according to claim 8, further comprising executing instructions occurring prior to the complex instruction during a first clock cycle.

15. A method according to claim 14, further comprising executing the complex instruction during a second clock cycle.

16. A method according to claim 15, wherein the step of shifting the instructions occurs while at least one of i) the instructions occurring prior to the complex instruction are executed and ii) the complex instruction is executed.

17. A method, comprising:
fetching an bundle of instructions having a complex instruction;
executing during a first clock cycle valid instructions occurring prior to the complex instruction;
executing the complex instruction during a second clock cycle;
shifting instructions occurring after the complex instruction during at least one of the first clock cycle and the second clock cycle;
edge detecting valid instructions occurring after the complex instruction during at least one of the first clock cycle and the second clock cycle; and
executing the valid instructions occurring after the complex instruction during a third clock cycle.
